(19) United States
(12) Patent Application Publication
(10) Pub. No.: US 2012/0238198 A1
(43) Pub. Date: Sep. 20, 2012

(54) FILTER ELEMENT AND METHOD FOR PRODUCING A FILTER ELEMENT

(75) Inventor: Anton RABANTER, Steinberg (DE)

(73) Assignee: MANN+HUMMEL GMBH, Ludwigsburg (DE)

(21) Appl. No.: 13/485,471

(22) Filed: May 31, 2012

Related U.S. Application Data
(63) Continuation of application No. PCT/EP2010/068751, filed on Dec. 2, 2010.

(30) Foreign Application Priority Data
Dec. 2, 2009 (DE) 10 2009 056 511.6

(51) Int. Cl. B60H 3/06; B29C 45/14

(52) U.S. Cl. 454/158; 264/258; 264/46.5

(57) ABSTRACT

A filter element (1), for example a cabin filter for a motor vehicle, includes a pleated fold pack (2), a plastic frame (4) that is molded at least in part to the fold pack (2) supporting pleat profiles (3), and a plastic foam seal (7) that is foamed at least in part onto the plastic frame (4). In a method for producing a corresponding filter element (1), a plastic frame (4) is generated at least in part around a fold pack (2) in a first injection molding process, and subsequently a plastic foam seal (7) is generated at least in part on the plastic frame (4) in a second injection molding process.

### CROSS REFERENCE TO RELATED APPLICATIONS

This application is bypass continuation of international patent application PCT/EP2010/068751 filed Dec. 2, 2010 designating the United States of America, the entire disclosure of which is incorporated herein by reference. Priority is claimed based on Federal Republic of Germany patent application no. 10 2009 056 511.6 filed Dec. 2, 2009.

### TECHNICAL FIELD

The present invention concerns a filter element, in particular a passenger compartment air filter for motor vehicles. Moreover, a method for producing filter elements is described.

In order to filter in the automotive field fluids such as fuels, other operating media or passenger compartment air, folded or pleated nonwoven filter materials are frequently employed. In this connection, it is often required to support the fold profiles by auxiliary means so that even in case of fluid passage the shape is maintained. Moreover, it is desired to seal the filter elements at their rims relative to the filter receptacle or the respective filter housing so that no unfiltered fluid can bypass the pleated filter medium.

### BACKGROUND OF THE INVENTION

In order to stabilize a zigzag-shaped filter medium with respect to the folds, in the past lateral straps of nonwoven filter material were attached to the fold profiles that, on the one hand, served for stabilization and, on the other hand, when provided with a projecting fold tab, served as a seal. Other known filter elements have been sealed by means of foam applied to the rims and the folds have been supported in this way. However, this sealing foam lip could be applied only at special locations due to manufacture-based reasons.

### SUMMARY OF THE INVENTION

The present invention has the object to provide an improved filter element and manufacturing method.

Accordingly, a filter element is provided which is in particular a passenger compartment air filter for a motor vehicle. The filter element has a fold pack, a plastic frame that is molded at least partially onto the fold pack, and a plastic foam seal that is at least partially foamed onto the plastic frame.

The plastic frame that is molded onto the fold pack serves, for example, for supporting fold profiles of the fold pack. Moreover, the plastic frame that is molded onto the fold pack can serve as a lateral seal, for example, relative to a filter receptacle.

The plastic frame and the plastic foam seal are preferably generated by an injection molding process. The filter element can be produced with particularly little expenditure because the otherwise conventional adhesive connection between a separate lateral strap and the fold pack is not required. By molding the plastic frame that is sufficiently rigid so as to impart stability to the fold pack, a good and stable connection with the fold profiles by injection molding is achieved. Also, by molding the plastic foam seal, for example, by means of a reaction molding process, any shapes for frame and seal can be realized.

The zigzag-shaped edge of the folded filter material sheet is be understood as profile of the folds or fold profile. The fold profile is thus positioned between two terminal fold sections of the fold pack.

The plastic frame can be, for example, made of thermoplastic materials such as polyamide and the plastic foam seal can be comprised, for example, of polyurethane foam. Of course, other materials are conceivable such as ABS plastic materials for the plastic frame or polypropylene. Thermoplastic materials are in principle suitable for injection molding.

In one embodiment of the filter element, a first and a second fold pack are provided that are separated by at least one frame stay of the plastic frame. The fold profiles are supported by the plastic frame and/or the frame stay. The fold packs can have different sizes in this connection so that the filter element can be matched to the geometry of the mounting conditions. The frame stay that, for example, defines several frame sections causes a further reinforcement of the entire filter element.

Preferably, the plastic foam seal surrounds an outer rim of the plastic frame that encloses the filter element. The flexible plastic foam then causes a reliable sealing action of the filter element at the respective housing for the filter element.

In a further embodiment, in the plastic frame of the filter element at least one opening is provided through which the plastic foam seal extends. In this way, an improved connection between the plastic foam seal and the plastic frame is achieved. The plastic foam seal that is injection molded can then pass in the not yet solidified state through the openings of the plastic frame and locks essentially upon solidification with the frame that, on the one hand, provides a fold profile stabilization and, on the other hand, supports the flexible foam seal.

As filter materials for the fold pack, for example, cellulose-containing materials, fiberglass blended fabrics, polyester fiber-containing materials, nonwoven material, and/or laminated papers are suitable.

Furthermore, a method for producing a filter element is proposed.

In this connection, a plastic frame is initially generated partially about a fold pack in a first injection molding step. Subsequently, in a second injection molding step, on the plastic frame at least partially a plastic foam seal is produced in a second injection molding step.

In comparison to conventional manufacturing processes, the method has the advantage that injection molding can be done particularly efficiently. Since the two materials for the plastic frame and the plastic foam seal can be selected such that a fixed connection of the boundary surfaces of both materials is realized, no additional adhesive connections must be carried out. By injection molding, a well-defined shape and geometry of the entire filter element can be achieved moreover. In case of, for example, cast foamed frames without injection molding, further after-processing steps must be carried out, for example, in order to remove flashes. When injection molding, the workpiece that is removed from the respective cavity of the injection molding tool, i.e., the finished filter element comprising fold pack, plastic frame and plastic foam seal, is complete and can be shipped.

The method comprises in one variant the steps of: insertion of a fold pack into a first injection molding tool; injection molding a plastic frame at least partially about the fold pack for supporting the fold profiles; insertion of the fold pack provided with the plastic frame into a second injection molding tool; and reaction molding of a plastic foam for forming the plastic foam seal on the plastic frame.

By means of only a few processing steps, a finished filter element with excellent mechanical properties due to the rigid plastic frame and a reliable rim sealing action due to the flexible plastic foam seal are thus provided.

In a variant of the method, the first and the second injection molding tool can be integrated into a single injection molding tool. The injection molding tool then comprises several cavities for forming the plastic parts. Accordingly, also semi-finished elements that, for example, comprise only the fold pack and the plastic frame, can be produced simultaneously with the formation of the plastic foam seal on another filter element. Accordingly, the first injection molding step can be realized with the first injection molding tool or a first cavity of the injection molding tool on a first fold pack and, simultaneously, the second injection molding step can be carried out with the second injection molding tool or a second cavity of the injection molding tool on a second fold pack provided with a plastic frame.

Preferably, it is provided in the method that several fold packs are enclosed such with a plastic frame that at least one frame stay supports fold profiles of different fold packs. As already mentioned, by means of the frame stay an improved stability can be achieved and, moreover, the space in a corresponding filter housing can be beneficially utilized by means of fold packs that also have irregular geometries.

In a further method variant, an injection molding tool comprised of two injection molding tool parts is used. Then only one of the injection molding tools is moved for opening and closing the injection molding tool. This has the advantage that only one of the tool parts, which, for example, may also comprise an integrated first and second injection molding tool, must be provided with appropriate automation means for movement.

In the manufacturing process, polyamides as plastic frame material and polyurethane foam as plastic foam seal material are preferably used.

Further possible implementations of the invention comprise also combinations, not explicitly mentioned, of the features, method steps or embodiment variants disclosed above or in the following with respect to the embodiments. In this connection, a person of skill in the art will also add individual aspects as improvements or supplements to the respective basic form of the invention.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 is a schematic perspective illustration of a first embodiment of a fold pack;

FIG. 2 is a schematic perspective illustration of a fold pack that is provided with a plastic frame, consistent with the present invention;

FIG. 3A is an enlarged detail of a portion of the filter element of FIG. 2, consistent with the present invention;

FIG. 3B is a detail view of FIG. 3A in cross-section;

FIG. 3C is a cross section of a filter element of FIG. 2 including a foam seal on the top side;

FIG. 3D is a cross section of a filter element of FIG. 2 including a foam seal on the radial side of the frame;

FIG. 4A is a schematic plan view illustration of a further development of the filter element, consistent with the present invention;

FIG. 4B is a schematic section through the filter element of FIG. 4A; and

FIGS. 5A-5F present illustrations for explaining variants of a manufacturing process for filter elements, consistent with the present invention.

In the Figures, same or functionally similar elements are provided with the same reference characters.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of apparatus components and method steps related to a filter element and a method of producing a filter element. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

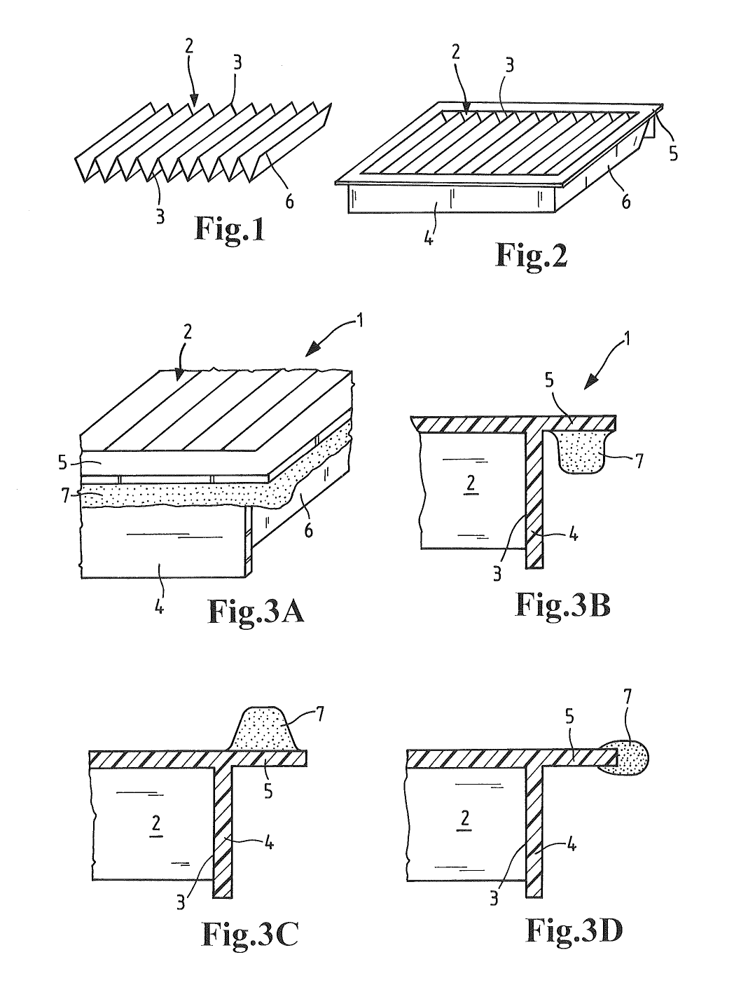

With the aid of FIGS. 1, 2 and 3A-3D, a first embodiment of a filter element is illustrated in simplified manufacturing stages. FIG. 1 shows in this connection a perspective illustration of a fold pack 2. The fold pack 2 is, for example, formed of a nonwoven filter material wherein known mechanisms such as blade folding or rotation folding are used. The nonwoven filter material can be, for example, heat-treated so that an improved fixation of the fold profiles 3 is obtained. The illustration of FIG. 1 shows forward and rearward fold profiles 3. The reference character 6 indicates a front end fold. Usually, onto the fold profiles 3 lateral straps are glued in order to impart stability to the entire fold pack 2. This is not required in case of the proposed filter element.

FIG. 2 shows a perspective illustration of a fold pack 2 that is already provided with a molded plastic frame 4. The fold pack 2 is secured at the fold profiles 3 by means of the molded plastic frame 4. The plastic frame 4 is, for example, produced by an injection molding process. One can see in FIG. 2 that the forward folds extend between the forward and rearward frame part 4. A connection between the fold profiles 3 and the plastic frame 4 that is formed of thermoplastic material is achieved by the selection of the injection molding tool. On the topside a circumferentially extending frame rim 5 is shown. The fold pack 2 is thus enclosed by the molded plastic frame 4. In a subsequent method step, also by means of an injection molding step or by reaction molding, a plastic foam seal is produced on the circumferentially extending rim 5.

In FIG. 3A, a detail is shown that corresponds in the orientation of FIG. 2 to the forward right corner of the finished filter element 1. One can see that on the rim 5 of the frame 4, in the orientation of FIG. 3A from below, a plastic foam seal 7 has been added. The shape of the plastic foam seal 7 can be predetermined by the selection of an injection molding tool. FIG. 3B shows the detail in cross-section. In this connection, the plastic frame 4 is connected with the fold profiles 3 of the fold pack 2. The plastic frame and the edges or the fold profiles are fused with each other, for example. On the bottom side of the circumferentially extending rim 5 of the plastic frame 4, the foam seal 7 has been applied by reaction molding. Accordingly, a filter element 1 with a fold pack, a plastic frame 4, and a foam seal 7 is produced. The foam seal and the plastic frame are produced by an injection molding method.

FIG. 3C shows a modified variant wherein, at the topside of the circumferentially extending rim 5 of the plastic frame 4, a foam seal 7 is provided that has been applied by reaction molding. The foam seal 7, for example, can be pushed seal-tightly against the wall (not illustrated) of the filter receptacle. Seals whose sealing action is developed upon pressing in the direction of the fluid flow to be filtered are referred to also as axial seals.

FIG. 3D shows a further variant of a filter element wherein a foam seal 7 is attached to a plastic frame 4. One can see that on the rim 5 of the plastic frame 4 a foam seal 7 has been added from the side. The shape of the plastic foam seal 7 can be predetermined again by the selection of an injection molding tool. Seals whose sealing action is developed upon pressing perpendicularly to the direction of the fluid flow to be filtered are referred to also as radial seals.

With the proposed foamed foam seals, radial as well as axial seals can be realized.

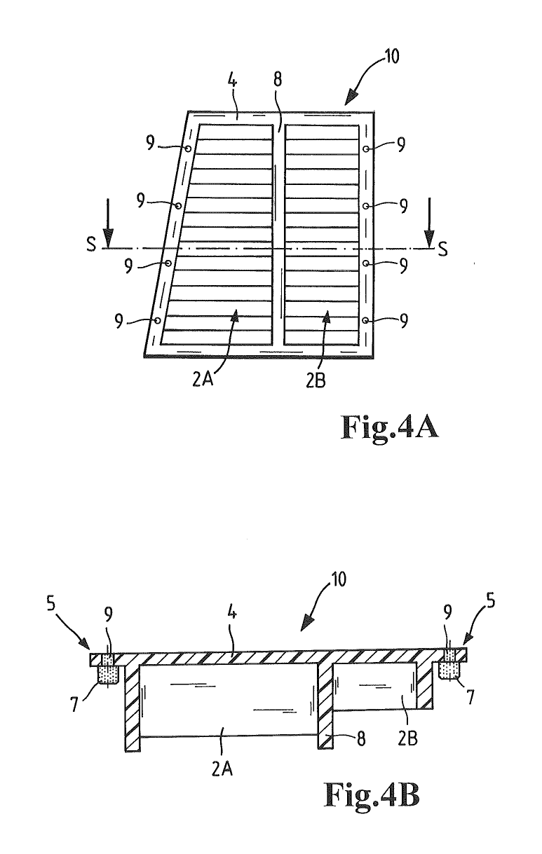

In FIGS. 4A and 4B a schematic illustration of a second embodiment of a filter element 10 is provided. The filter element 10 comprises in this connection two fold packs 2A and 2B. FIG. 4A shows in plan view that two separate fold packs 2A, 2B are separated by a stay 8 of the plastic frame 4. In FIG. 4B a cross-section through the filter element 10 along the line S is illustrated. One can see that the stay 8 is arranged between the two fold packs 2A and 2B and therefore both fold profiles are supported. In this way, a stable plastic frame 4 results whose rim predetermines the geometry of the filter element 10.

The plastic frame 4 or its rim 5 is provided moreover with openings or holes 9. When injection molding the plastic foam seal 7, the foaming plastic material can pass through these holes 9. The plastic foam material closes off the holes 9 so that, as illustrated in cross-section of FIG. 4B, the resulting plastic foam seal or plastic foam lip 7 adheres particularly reliably to the frame 4.

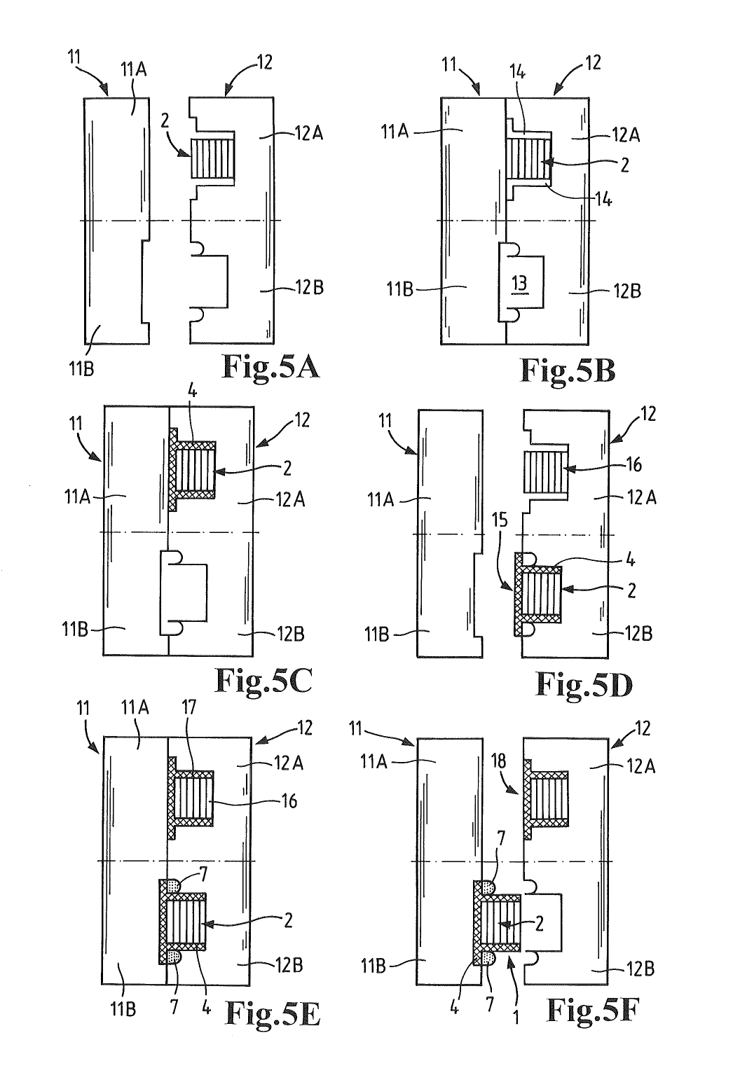

FIGS. 5A-5F show illustrations for explaining variants of a manufacturing process of a corresponding filter element. The manufacture will be explained with the aid of an injection molding tool. In FIGS. 5A-5F, a two-part injection molding tool 11, 12 is illustrated. In this connection, the upper part 11A, 12A of the injection molding tool forms a first upper cavity or a hollow space and the lower part 11B, 12B of the injection molding tool forms a lower cavity.

In the manufacturing process, a fold pack is initially produced and made available. Subsequently, the fold pack 2 is inserted into the upper cavity 11A, 12A as illustrated in FIG. 5A. In this connection, the cavity or the hollow space, for example, the part 12A, may have fixation means for the inserted folds. Subsequently, as illustrated in FIG. 5B, the injection molding tool is closed. First, only the upper part 11A, 11B will be considered. There are two hollow spaces 13, 14 in the injection molding tool 11A, 12A, 11B, 12B. In the upper part of the injection molding tool 11A, 12A, the hollow space 14 corresponds to the shape of the plastic frame to be formed. In accordance with known injection molding processes, liquid plastic material is now introduced into the cavities 14, i.e., injected into the injection molding tool. After cooling down, an injection-molded plastic frame 4 about the fold pack 2 is realized as illustrated in FIG. 5C. In the Figures, the fold pack 2 is hatched vertically and the plastic frame 4 is cross-hatched.

The injection molding tool is now opened. For example, only the left half 11 of the injection molding tool is moved in this connection. In this way, the apparatus expenditure for injection molding can be reduced. FIG. 5D shows the open injection molding tool 11, 12. The fold pack 2 provided with the plastic frame 4 can be referred to as a semi-finished filter element 15. The semi-finished filter element 15 is now inserted into the cavity of the lower part of the injection molding tool 12B. At the same time, into the upper part of the injection molding tool 12A a new fold pack 16 can be inserted.

Now the injection molding tool is closed. In the lower cavity 11B, 12B a reaction molding process is carried out in order to produce an injection-molded foam. At the same time, the inserted fold pack 16 is provided with a plastic frame 17 in the upper cavity 11A, 12A. In the lower cavity, on the other hand, the plastic foam seal 7 is formed.

FIG. 5F shows again the open injection molding tool wherein the finished filter element 1 can be removed from the lower part of the injection molding tool 11B, 12B and can be shipped. The upper semi-finished filter element 18 is now inserted, in analogy to FIGS. 5C and 5D, into the lower part of the injection molding tool and provided with the seal.

The two-part configuration of the injection molding tool provides a particularly efficient and fast cycle timing in the production of the filter elements.

In comparison to known methods, by the proposed plastic injection molding with integrated foam seal, for example of PUR, a fast and inexpensive production of filter elements is possible. While in the conventional frames, even foamed ones, only simple geometries are possible in general, by means of reaction molding any geometry for frame and seal can be achieved. The seal can be, for example, also produced adjacent to the outer rim (axial) or about the outer rim (radial). After-processing is not required because upon injection molding or reaction molding no disturbing flashes are produced on the manufactured components. Manufacture of the filter elements is therefore possible in a particularly simple and inexpensive way.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims The invention is defined solely by the appended claims including any amendments made during the pendency of this application and all equivalents of those claims as issued.

1. A filter element comprising:
a fold pack of a pleated filter medium having forward and rearward fold profiles;
a plastic frame molded at least partially onto said fold pack, securing said fold pack to said plastic frame; and
a plastic foam seal secured onto and foamed at least partially onto said plastic frame.

2. The filter element according to claim 1, wherein
said plastic frame and said plastic foam seal are produced by an injection molding process.

3. The filter element according to claim 1, wherein
said plastic frame is a polyamide thermoplastic material; and
wherein said plastic foam seal comprises a polyurethane foam.

4. The filter element according to claim 1, wherein
said fold pack is a first fold pack;
wherein said filter element includes a second fold pack;
wherein said filter element includes at least one frame stay positioned between and secured at one side onto a lateral edge of said first fold pack, said frame stay secured at an opposing second side onto a lateral edge of said second fold pack;
wherein fold profiles of said first and second fold packs are supported by the plastic frame and/or said frame stay.

5. The filter element according to claim 1, wherein
said plastic frame includes an outer rim extending radially outwardly from said filter element, radially circumferentially enclosing said filter element;
wherein said plastic foam seal is secured onto and extends along said outer rim of said plastic frame.

6. The filter element according to claim 1, wherein
said plastic frame has at least one opening extending through said plastic frame;
wherein said plastic foam seal extends through said at least one opening.

7. The filter element according to claim 1, wherein
said fold pack comprises any of a cellulose-containing material, fiberglass blended fabric, polyester fiber-containing material, nonwoven material and/or laminated papers as filter material.

8. A method of producing a filter element, comprising:
providing a fold pack of a pleated filter medium having forward and rearward fold profiles;
practicing a first injection molding step forming a plastic frame of a moldable plastic material at least partially circumferentially about said fold pack, wherein said first injection molding step also secures said fold pack to said plastic frame; and
producing a plastic foam seal at least partially onto and secured to said plastic frame in a second injection molding step.

9. The method of producing a filter element according to claim 8,
wherein before the practicing step the method further comprises:
providing a first injection mold and a second injection mold;
inserting said fold pack into said first injection mold;
wherein in said practicing step, said plastic frame secured to said fold pack supports said fold profiles;
wherein said producing step includes
inserting said fold pack with said plastic frame into said second injection mold; and
reaction molding said plastic foam seal onto said plastic frame in said second injection mold.

10. The method of producing a filter element according to claim 8,
said first and said second injection molds are integrated into a single injection molding tool.

11. The method of producing a filter element according to claim 10,
wherein before said producing step, the method further includes
removing said plastic frame and fold pack from said first injection mold;
inserting another fold pack into said first injection mold; and
wherein said practicing step and said producing step are carried out simultaneously on different fold packs.

12. The method of producing a filter element according to claim 8,
wherein said filter element includes a plurality of fold packs;
wherein said plurality of old packs are molded to said plastic frame; and
wherein said practicing step includes
molding at least one frame stay positioned between and secured onto lateral edges of said plurality of fold packs, said frame stay supporting fold profiles of said plurality of fold packs.

13. The method of producing a filter element according to claim 10, wherein
said single injection molding tools includes two injection molding tool parts; and
wherein exclusively one of said injection molding tool parts is moved for opening and closing said single injection molding tool.

14. The method of producing a filter element according to claim 8, wherein
in said practicing step, said moldable plastic material is polyamide.

15. The method of producing a filter element according to claim 8, wherein
in said producing step, said plastic foam is a polyurethane foam.
